(19) United States
(12) Patent Application Publication
(10) Pub. No.: US 2025/0348028 A1
(43) Pub. Date: Nov. 13, 2025

(54) IMAGE FORMING APPARATUS

(71) Applicant: CANON KABUSHIKI KAISHA, Tokyo (JP)

(72) Inventor: NORIAKI SATO, Shizuoka (JP)

(21) Appl. No.: 19/199,757

(22) Filed: May 6, 2025

(30) Foreign Application Priority Data
May 8, 2024 (JP) 2024-075702

(51) Int. Cl. G03G 15/20; G03G 15/00; G03G 21/16

(52) U.S. Cl. CPC G03G 15/2035; G03G 15/55; G03G 15/70; G03G 21/1638; G03G 21/1685; G03G 2215/00548; G03G 2221/1639; G03G 2221/1675

(57) ABSTRACT

An image forming apparatus includes an image forming unit, a fixing unit, an open/close member, and a notification unit, wherein the fixing unit is movable by a user's operation between a first position where image forming is performed and a second position different from the first position, in a state where the open/close member is opened, wherein in a case where a paper jam occurs during the image forming, the notification unit notifies the user to open the open/close member and remove a recording medium, and wherein in a case where the user moves the fixing unit from the first position to the second position or the image forming apparatus detects a start of moving the fixing unit to the second position after the user is notified, the notification unit notifies the user to remove the recording medium after returning the fixing unit to the first position.

### BACKGROUND

### Field of the Disclosure

The present disclosure relates to an image forming apparatus for forming a toner image on a recording medium using an electrophotographic recording technology, such as a copying machine and a printer.

### Description of the Related Art

An electrophotographic method image forming apparatus includes a fixing unit (fixing device) for fixing a toner image on a recording medium. Japanese Patent Application Laid-open No. 2012-47806 discusses a printer in which a fixing unit is movable from a first position for forming an image to a second position different from the first position. By moving the fixing unit to the second position, attaching and detaching the fixing unit, replacement work of the fixing unit, and maintenance work such as a removal of a jammed recording medium (paper jam clearance operation) become easy, and the user's convenience improves.

However, in the image forming apparatus with the movable fixing unit, there may be a case where the paper jam clearance operation is difficult.

### SUMMARY

Embodiments of the present disclosure are directed to an image forming apparatus having a guidance function for allowing a user to easily perform a paper jam clearance operation.

According to an aspect of the present disclosure, an image forming apparatus includes an image forming unit configured to form a toner image on a recording medium, a fixing unit configured to fix the toner image formed on the recording medium onto the recording medium, an open/close member configured to be openable so that an inside of the image forming apparatus is opened, and a notification unit configured to notify a user, wherein the fixing unit is configured to be movable by a user's operation between a first position at which image forming is performed and a second position different from the first position, in a state where the open/close member is opened, wherein in a case where a paper jam of the recording medium occurs during the image forming, the notification unit notifies the user to open the open/close member and remove the recording medium, and wherein in a case where the user moves the fixing unit from the first position to the second position or the image forming apparatus detects a start of moving the fixing unit to the second position after the user is notified, the notification unit notifies the user to remove the recording medium after returning the fixing unit to the first position.

According to another aspect of the present disclosure, an image forming apparatus includes an image forming unit configured to form a toner image on a recording medium, a fixing unit configured to fix the toner image formed on the recording medium onto the recording medium, an open/close member configured to be openable so that an inside of the image forming apparatus is opened, and a notification unit configured to notify a user, wherein the fixing unit is configured to be movable by a user's operation between a first position at which image forming is performed and a second position different from the first position, in a state where the open/close member is opened, and wherein in a case where a paper jam of the recording medium occurs during the image forming, the notification unit notifies the user to open the open/close member and remove the recording medium without moving the fixing unit to the second position.

Further features of various embodiments will become apparent from the following description of exemplary embodiments with reference to the attached drawings.

### BRIEF DESCRIPTION OF THE DRAWINGS

FIG. 1 is a cross-section diagram illustrating an entire configuration of an image forming apparatus.

FIG. 2 is a cross-section diagram illustrating a fixing device (fixing unit).

FIG. 3 is a cross-section diagram illustrating a state where an open/close member of the image forming apparatus is opened.

FIG. 4 is a cross-section diagram illustrating a state where the fixing device has been moved to a second position (retreat position) after the open/close member is opened.

FIG. 5 is a cross-section diagram illustrating a state where a cartridge has been moved to an attachable/detachable position from the state in FIG. 4.

FIGS. 6A and 6B are cross-section diagrams illustrating a retreating mechanism of the fixing device.

FIG. 7 is a flowchart illustrating a procedure of a paper jam clearance operation according to a first exemplary embodiment.

FIG. 8 is a diagram illustrating a display screen displayed when the paper jam clearance operation is performed, according to the first exemplary embodiment.

FIG. 9 is a diagram illustrating a display screen displayed when the paper jam clearance operation is performed, according to the first exemplary embodiment.

FIG. 10 is a cross-section diagram illustrating an issue arising when the paper jam clearance operation is performed.

FIG. 11 is a cross-section diagram illustrating an issue arising when the paper jam clearance operation is performed.

FIG. 12 is a flowchart illustrating a procedure of a paper jam clearance operation according to a second exemplary embodiment.

FIG. 13 is a diagram illustrating a display screen displayed when the paper jam clearance operation is performed, according to the second exemplary embodiment.

### DESCRIPTION OF THE EMBODIMENTS

Configurations to achieve the present disclosure will be described in detail based on exemplary embodiments. Note that dimensions, materials, and shapes of the constituent parts, and relative arrangements thereof described below in the exemplary embodiments should be changed appropriately depending on the configurations or various kinds of conditions of an apparatus to which the present disclosure is applied. Note also that the range of the present disclosure is not limited to the following exemplary embodiments.

### Entire Configuration

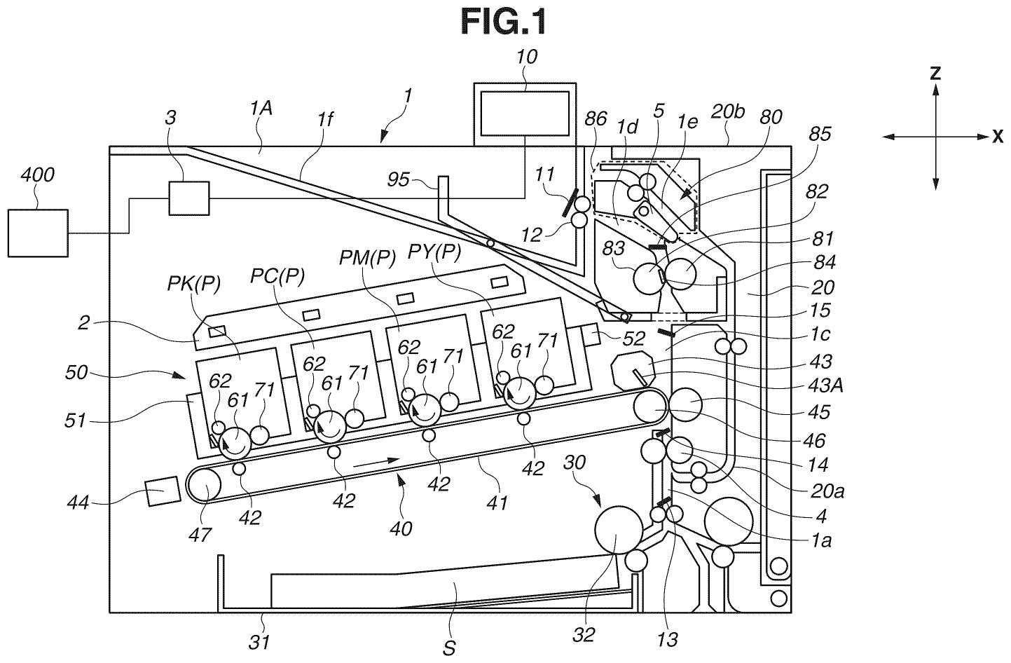

With reference to FIG. 1, a printer 1 serving as an image forming apparatus will be described. FIG. 1 is a cross-section diagram illustrating an entire configuration of the printer 1 according to a first exemplary embodiment. In the present exemplary embodiment, the printer 1 is an electrophotographic method color laser beam printer that forms a toner image on a sheet S serving as a recording medium.

The printer 1 includes a housing 1A, a scanner (exposure device) 2, a control unit 3, and a door (open/close member) 20 that is openable and closable relative to the housing 1A, so that the inside of the printer 1 is opened. Further, the printer 1 includes a sheet feed unit 30, a transfer unit 40, a tray unit (also referred to as a moving unit or a support unit) 50, and a fixing device (fixing unit) 80.

The housing 1A houses the scanner 2, the control unit 3, the sheet feed unit 30, the transfer unit 40, the tray unit 50, and the fixing device 80. The sheet feed unit 30 includes a stack tray 31 for stacking the sheets S (recording media such as paper) and includes a feed roller 32. The sheets S can be refilled on the stack tray 31 by pulling out the stack tray 31 in a direction toward the door 20.

The tray unit 50 is composed of a tray (support member or drawer) 51, cartridges PY, PM, PC, and PK, and a tray handle 52. Each of the cartridges PY, PM, PC, and PK is independently attachable to and detachable from the tray 51. The cartridges PY, PM, PC, and PK respectively contain toners (developing materials) of yellow (Y), magenta (M), cyan (C), and black (K). The cartridges PY, PM, PC, and PK have a same configuration except that the colors of contained toners are different. Accordingly, a configuration and an operation of one of the cartridges PY, PM, PC, and PK are described, and descriptions about other cartridges are omitted. In a case where the cartridges PY, PM, PC, and PK are not required to be distinguished, the cartridges PY, PM, PC, and PK may sometimes be simply referred to as a cartridge P or cartridges P.

In the present exemplary embodiment, the tray unit 50 includes a photosensitive drum (image bearing member) 61, a charging roller (charging member) 62, and a developing roller (developer bearing member) 71 for each of the four cartridges P. The rotational axis directions of the photosensitive drums 61, the developing rollers 71, and the charging rollers 62 are parallel to each other.

A part for forming a black (K) toner image is referred to as a first station or a black station, and the corresponding photosensitive drum 61 of the first station is referred to as a first photoconductive drum, the corresponding developing roller 71 is referred to as a first developing roller, and the corresponding charging roller 62 is referred to as a first charging roller.

A part for forming a cyan (C) toner image is referred to as a second station or a cyan station, the corresponding photosensitive drum 61 of the second station is referred to as a second photoconductive drum, the corresponding developing roller 71 is referred to as a second developing roller, and the corresponding charging roller 62 is referred to as a second charging roller.

A part for forming a magenta (M) toner image is referred to as a third station or a magenta station, the corresponding photosensitive drum 61 of the third station is referred to as a third photoconductive drum, the corresponding developing roller 71 is referred to as a third developing roller, and the corresponding charging roller 62 is referred to as a third charging roller.

A part for forming a yellow (Y) toner image is referred to as a fourth station or a yellow station, the corresponding photosensitive drum 61 of the fourth station is referred to as a fourth photoconductive drum, the corresponding developing roller 71 is referred to as a fourth developing roller, and the corresponding charging roller 62 is referred to as a fourth charging roller.

The cartridges PK, PC, PM, and PY are respectively attached to the black, cyan, magenta, and yellow stations.

The numbers, such as the first, second, third, and fourth, are used for the convenience of descriptions.

In the present exemplary embodiment, each of cartridges PY, PM, PC, and PK includes the photosensitive drum 61, the charging roller 62, and the developing roller 71, but the tray 51 may include them.

The transfer unit 40 includes a transfer belt 41, primary transfer rollers 42, a cleaning unit 43, a drive roller 46 for driving the transfer belt 41, and a tension roller (driven roller) 47. In the printer 1 according to the present exemplary embodiment, an optical sensor 44 for detecting the toner image transferred onto the transfer belt 41 is disposed. In the present exemplary embodiment, the transfer belt 41 is disposed below the photosensitive drums 61, and can contact the photosensitive drums 61 by the primary transfer rollers 42 so that primary transfer portions are formed between the transfer belt 41 and the respective photosensitive drums 61. The printer 1 includes a secondary transfer roller 45 in contact with the transfer belt 41 so as to form a secondary transfer portion. The secondary transfer portion is formed between the transfer belt 41 and the secondary transfer roller 45. The rotational axis directions of the primary transfer rollers 42, the drive roller 46, the tension roller 47, and the secondary transfer roller 45 are parallel to each other. A registration roller pair 4 is disposed below the secondary transfer portion. The first to fourth stations, the primary transfer rollers 42, the transfer belt 41, the secondary transfer roller 45 described above correspond to an image forming unit for forming a toner image on the sheet S.

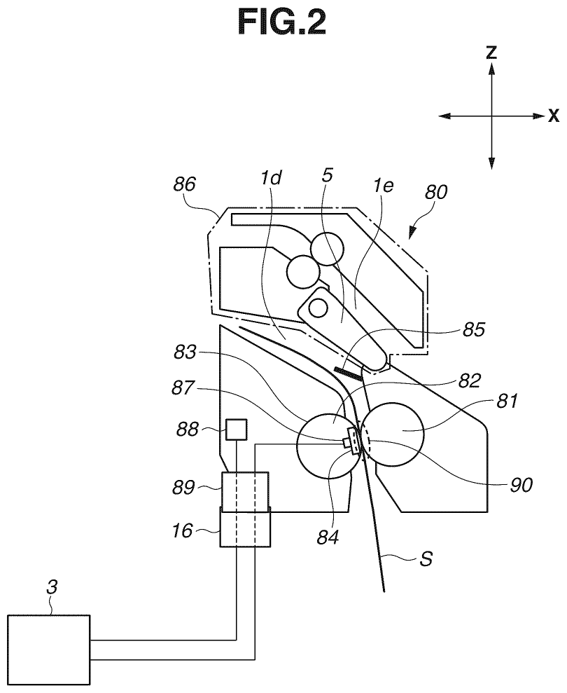

With reference to FIG. 2, the fixing device 80 will be described. The fixing device 80 includes a heating unit 82 with a ceramic heater 84 disposed inside a fixing belt 83, and a pressure roller 81 disposed at an opposing position of the ceramic heater 84 via the fixing belt 83 to nip and convey the sheet S in cooperation with the fixing belt 83. At a fixing nip portion 90 at which the fixing belt 83 and the pressure roller 81 are pressed and brought into contact with each other, the sheet S is heated and pressed so that fixing processing of the toner image is performed.

The fixing device 80 includes a flapper 5 for switching the conveyance path of the sheet S between a sheet discharge path 1d for guiding the sheet S to a sheet discharge roller pair 12 after the sheet has been S subjected to the fixing processing, and a reversing path le direction. The fixing device 80 is configured to be located at a first position illustrated in FIG. 1, and the sheet S is nipped and conveyed while being heated at the fixing nip portion 90, when an image forming operation is performed on the sheet S. A fixed sheet discharge unit 86 (portion surrounded by dashed-dotted lines in FIG. 2) disposed on a downstream side of the fixing device 80 in the sheet conveyance direction can be opened and closed relative to the main body of the fixing device 80 to enable easy access to the vicinity of the fixing nip portion 90 when the sheet S is jammed in the fixing device 80.

A thermistor (temperature detection element) 87 in FIG. 2 is an element to detect the temperature of the ceramic heater 84. A memory unit 88 is provided in the fixing device 80, to store characteristic information about the fixing device 80. Examples of the characteristic information about the fixing device 80 include compatible voltages supplied to the fixing device 80, such as 100 V and 200 V. In FIG. 2, a connector 89 is a connector on the fixing device 80, a connector 16 is a connector on the housing 1A of the printer 1, and the information about the detected temperature signal of the thermistor 87 and the information in the memory unit 88 are transmitted to the control unit 3 in the housing 1A of the printer 1, via the connectors 89 and 16. The control unit 3 controls the energization of the ceramic heater 84 based on the information stored in the memory unit 88 and the temperature signal detected by the thermistor 87.

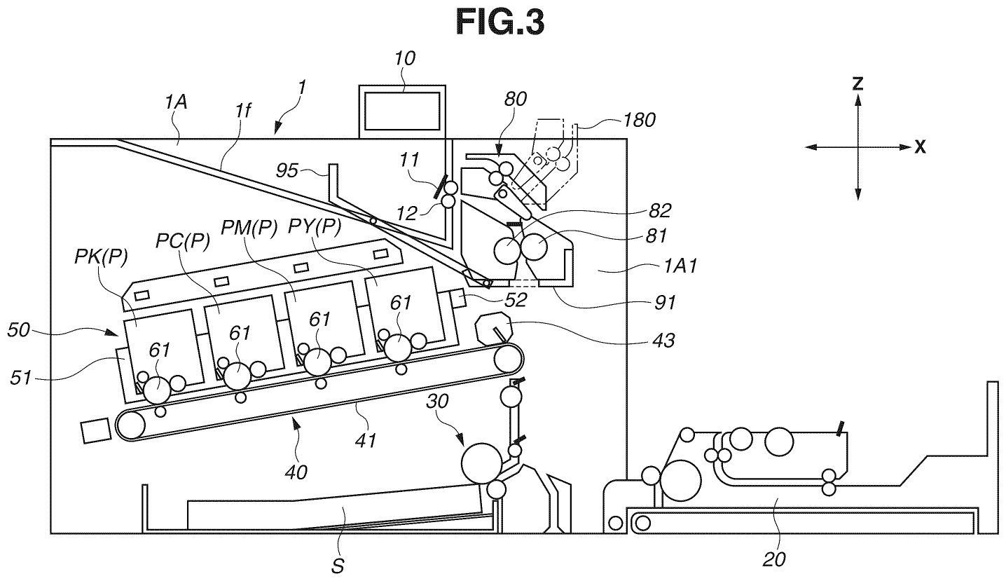

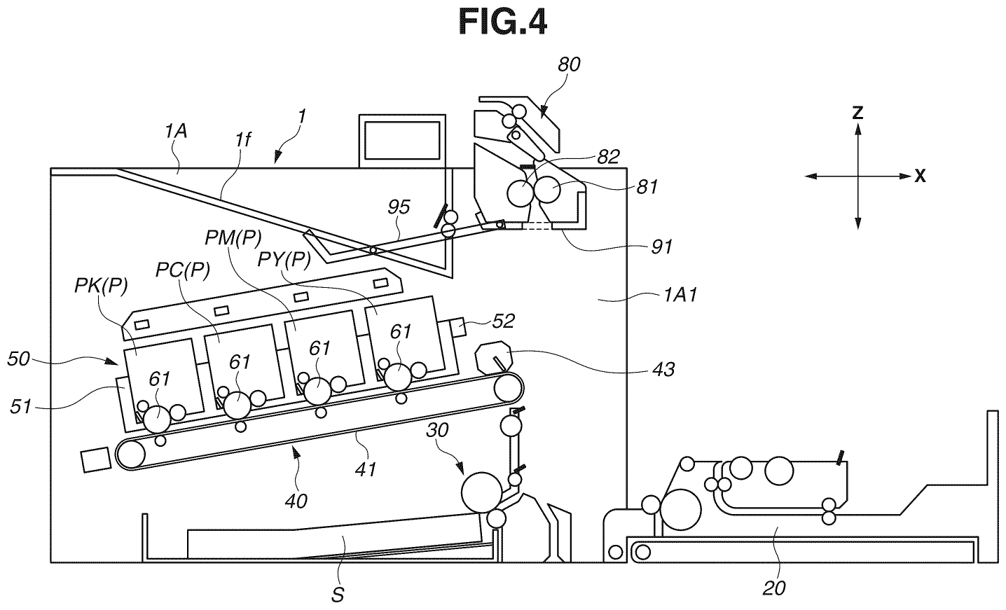

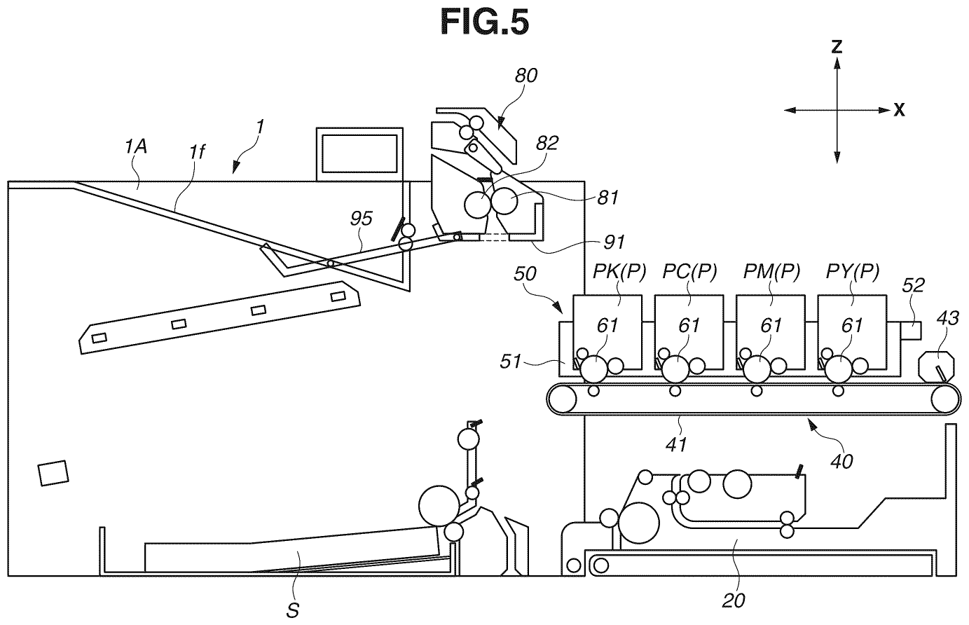

With reference to FIGS. 1, 3, 4, and 5, the movement of the transfer unit 40 and the tray unit 50 will now be described. FIG. 3 is a cross-section diagram illustrating a state where the door 20 is opened, FIG. 4 is a cross-section diagram illustrating a state where the fixing device 80 has further moved and retreated from the state in FIG. 3, and FIG. 5 is a cross-section diagram illustrating a state where the tray unit 50 and the transfer unit 40 have moved to the outside position of the housing 1A from the state in FIG. 4.

The transfer unit 40 and the tray unit 50 can be moved from the inside position of the housing 1A to the outside position of the housing 1A through an opening 1A1 formed by opening the door 20. The moving direction of the transfer unit 40 and the tray unit 50 is a direction orthogonal to the rotational axis direction of each of the photosensitive drums 61.

The fixing device 80 is disposed on the opening 1A1 of the housing 1A in a horizontal direction X. The door 20 attached to the housing 1A can rotatably move between the closed position and the open position. As illustrated in FIG. 1, in a state where the door 20 is at the closed position, the door 20 covers the opening 1A1. As illustrated in FIG. 3, in a state where the door 20 is at the open position, the opening 1A1 is formed.

As illustrated in FIG. 1, in a state where the door 20 is at the closed position, the door 20 covers the fixing device 80 attached to the housing 1A. More specifically, in the state where the door 20 is at the closed position, an upper cover portion 20b of the door 20 is located above the fixing device 80.

With a retreating mechanism of the fixing device 80 described below, the fixing device 80 can move and retreat from the state in FIG. 3 to the state in FIG. 4. In FIGS. 1, 3, 4, and 5, a support arm 95 is a support arm that is a part of the configuration member of the retreating mechanism. The fixing device 80 is attachable to and detachable from the printer 1, and is replaced with a new fixing device 80 when the consumable part reaches the end of its life. As illustrated in FIG. 5, in a state where the door 20 and the fixing device 80 have been moved, the transfer unit 40 and the tray unit 50 are movable from the inside position of the housing 1A to the outside position of the housing 1A through the opening 1A1.

In a state where the tray unit 50 and the transfer unit 40 have been moved outside the housing 1A (see FIG. 5), the cartridges PY, PM, PC, and PK can be detached from the tray 51, and can be attached to the tray 51. In this way, the cartridges PY, PM, PC, and PK can be replaced with new cartridges PY, PM, PC, and PK.

The transfer unit 40 can be pulled out and detached from the housing 1A, in an independent manner from the tray unit 50, and can be replaced with a new transfer unit 40.

These are all the descriptions of the printer 1 according to the present exemplary embodiment.

### Image Forming Operation

With reference to FIG. 1, the image forming operation of the printer 1 will be described. The control unit 3 of the printer 1 starts the toner image forming operation onto the sheet S based on an image signal received from an external host apparatus 400. The external host apparatus 400 is, for example, a personal computer, an image reader, or a facsimile machine.

When the image forming operation onto the sheet S is performed, the fixing device 80 is located at the first position, the tray unit 50 and the transfer unit 40 are located at the inside position, and the door 20 is located at the closed position. In the state where the transfer unit 40 is located at the inside position, the transfer belt 41 can contact the photosensitive drum 61.

A charging voltage is applied to each of the charging rollers 62, and each of the corresponding photosensitive drums 61 rotates. A laser beam corresponding to the image information is emitted from the scanner 2 to each of the photosensitive drums 61, the surface of each of the corresponding photosensitive drums 61 charged by the corresponding charging rollers 62 is exposed to the laser beam. In this way, an electrostatic latent image corresponding to the image information is formed on the surface of each of the photosensitive drums 61.

A developing voltage is applied to each of the developing rollers 71 with the toner borne thereon, and the electrostatic latent image formed on each of the photosensitive drums 61 is developed with the toner supplied from the corresponding developing roller 71 to form a toner image on the surface of each of the photosensitive drums 61. In the present exemplary embodiment, each of the developing rollers 71 develops the electrostatic latent image in a state where each of the developing rollers 71 is in contact with the corresponding photosensitive drum 61, but each of the developing rollers 71 may develop the electrostatic latent image with a gap between each of the developing rollers 71 and the corresponding photosensitive drum 61.

When a full color image is formed, toner images of respective colors are formed on the photosensitive drums 61.

Each of the developing rollers 71 can move between a contact position at which each of the developing rollers 71 contacts the corresponding photosensitive drum 61, and a separated position at which each of the developing rollers 71 is separated from the corresponding photosensitive drum 61, in the state where the tray unit 50 is located at the inside position.

More specifically, a switching device (not illustrated) provided in the housing 1A can switch the state of each of the developing rollers 71 between the state where each of the developing rollers 71 is located at the contact position and the state where each of the developing rollers 71 is located at the separated position. In a state where the image forming operation is not performed, each of the developing rollers 71 can be separated from the corresponding photosensitive drum 61.

The printer 1 can perform monochromatic printing in a state where only the developing roller 71 and the photosensitive drum 61 corresponding to the cartridge PK are brought into contact with each other, and the developing rollers 71 and the photosensitive drums 61 respectively corresponding to the cartridges PY, PM, and PC are separated from each other.

The toner images formed on the photosensitive drums 61 are sequentially transferred onto the transfer belt 41 by the primary transfer rollers 42 at primary transfer portions, respectively, and move toward the secondary transfer portion formed by the transfer belt 41 and the secondary transfer roller 45.

A conveyance path 1c through which the sheet S that is moving toward the fixing device 80 passes is formed in the housing 1A, and a two-sided conveyance path 20a through which the sheet S that has passed through the fixing device 80 and guided to the reversing path le passes after the moving direction of the sheet S is switched is formed inside the door 20. When the door 20 is opened, the conveyance path 1c and a part of the two-sided conveyance path 20a are exposed.

In the sheet feed unit 30, one sheet S is separated and fed from the sheets S stacked on the stack tray 31 at a predetermined timing by the feed roller 32, and is conveyed toward the secondary transfer portion through a sheet feed conveyance path 1a.

At the secondary transfer portion, the toner image is transferred from the transfer belt 41 onto the sheet S. The toner not transferred onto the sheet S is removed from the transfer belt 41 by a cleaning blade (cleaning member) 43A provided in the cleaning unit 43.

The sheet S with the toner image transferred thereon at the secondary transfer portion is conveyed toward the fixing device 80. In the fixing device 80, the toner image is fixed onto the sheet S. The sheet S with the toner image fixed thereon is conveyed toward the flapper 5 serving as a conveyance path switching unit.

The flapper 5 can move between a sheet discharge position, for guiding the sheet S that has passed through the fixing device 80 toward the sheet discharge path 1d, and a reversing position, for guiding the sheet S toward the reversing path 1e.

In a case where one-sided printing is performed, the sheet S is guided to the sheet discharge path 1d by the flapper 5, then conveyed by the sheet discharge roller pair 12, and discharged onto a discharge tray If formed on an upper part of the housing 1A.

In a case where two-sided printing is performed, the sheet S is guided by the flapper 5 to the reversing path le. After the sheet S is guided to the reversing path 1e, the conveyance direction of the sheet S is reversed, and the sheet S is conveyed toward the secondary transfer portion again through the two-sided conveyance path 20a formed on the inside of the door 20. Then, the toner image is transferred onto the back side of the sheet S at the secondary transfer portion, then the sheet S passes through the fixing device 80 again, guided to the sheet discharge path 1d by the flapper 5, and discharged by the sheet discharge roller pair 12 onto the discharge tray 1f.

On the sheet conveyance path of the printer 1, a plurality of sensors capable of detecting the presence/absence of the sheet S is disposed. As illustrated in FIG. 1, a sheet feed portion sensor 13, a registration portion sensor 14, a transfer-fixing in-between portion sensor 15, a fixed sheet discharge portion sensor 85, and a sheet discharge portion sensor 11 are provided. The signals detected by the respective sensors are transmitted to the control unit 3, and the position of the conveyed sheet S can be detected.

In a case where a paper jam has occurred, the printer 1 detects that the sheet S has not been conveyed normally based on the sensor signals described above, and the printer 1 detects that the paper jam has occurred. In this case, the printer 1 stops the image forming operation and displays a notification on a display unit (liquid crystal display) 10 serving as a notification unit to notify the user of the occurrence of the paper jam and a handling method including a paper jam clearance operation method. Since the paper jam clearance operation is performed in a state where the door 20 is open, the display unit 10 is disposed at a position at which the user can visually recognize the display unit 10 in a state where the door 20 is open. In the present exemplary embodiment, the display unit 10 is disposed on a main body upper surface portion near the door open/close portion. The printer 1 may transmit the similar notification contents to also the external host apparatus 400, such as a personal computer, to display the notification contents on a display unit of the external host apparatus 400 to notify the user thereof.

In a case where the printer 1 detects the paper jam and stops its operation, the user may perform the paper jam clearance operation to remove the sheet S remaining in the conveyance path. In this case, as illustrated in FIG. 3, the user opens the door 20 that is openable and closable provided on the right side of the printer 1 to remove the sheet S remaining in the conveyance path.

In a case where the sheet S is stopped in a state of being pinched in the fixing device 80, the user removes the sheet S by pulling out the sheet S from a sheet entrance or a sheet exit of the fixing device 80. In a case where the sheet S is to be removed from the sheet exit, the user opens the fixed sheet discharge unit 86, which is openable/closable as needed, to a position 180 illustrated in FIG. 3, to remove the sheet S remaining in the fixing device 80.

### Retreating Mechanism of Fixing Device

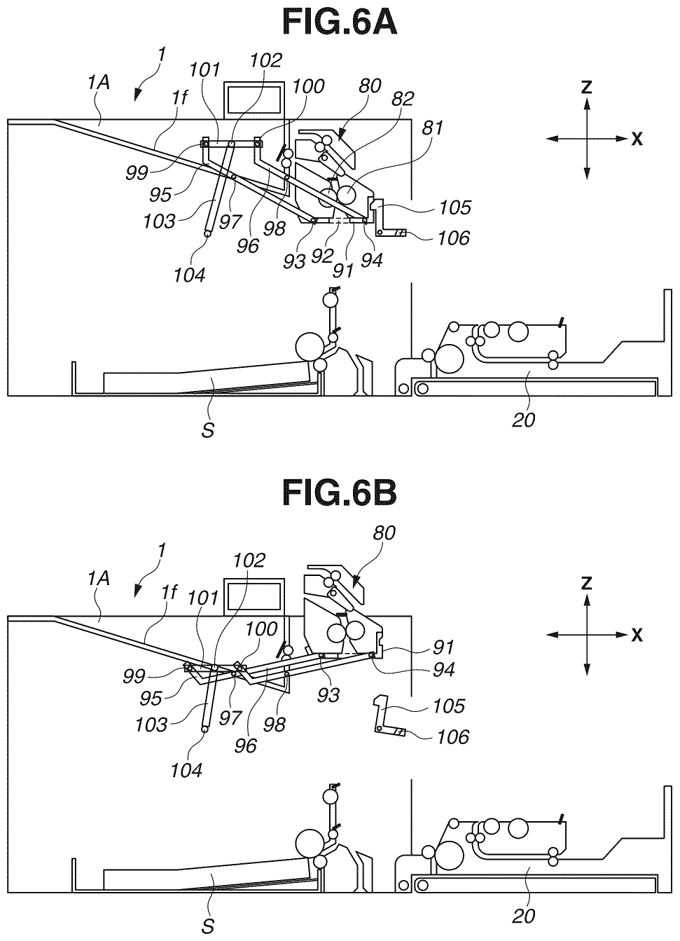

With reference to FIGS. 6A and 6B, the retreating mechanism of the fixing device 80 will be described. FIG. 6A is a cross-section diagram illustrating a state where the fixing device 80 is located at the first position, and FIG. 6B is a cross-section diagram illustrating a state where the fixing device 80 has moved to a second position (retreat position).

The fixing device 80 is attached to the printer 1 in a state of being mounted on a holding base 91 for receiving the bottom surface of the fixing device 80. The holding base 91 is made of a metal plate and has an opening 92 in a passing area for the sheet S in the holding base 91. The holding base 91 is connected with the support arms 95 and 96 respectively via rotatable connection portions 93 and 94. The support arms 95 and 96 are rotatably connected with fulcrums 97 and 98 fixed to the frame of the printer 1, and the support arms 95 and 96 are further connected with a connection arm 101 via rotatable connection portions 99 and 100, respectively. The connection arm 101 is connected to one end of an extension spring 103 via a connection portion 102, and the other end of the extension spring 103 is connected to a connection portion 104 fixed to the frame of the printer 1.

The support arms 95 and 96 are arranged at positions so as not to interfere with the fixing device 80. The retreating mechanisms such as the support arms 95 and 96 are respectively provided on both ends of the printer 1 in the longer side direction (direction perpendicular to both X and Z directions) of the fixing device 80. FIGS. 6A and 6B illustrate the retreating mechanism as seen from the front side of the printer 1.

As illustrated in FIGS. 6A and 6B, the fixing device 80 is urged upward together with the holding base 91, by the force of the extension spring 103. In order to fix the fixing device 80 to the image forming position, a lock mechanism 105 is provided on the main body of the printer 1 as illustrated in FIG. 6A. The fixing is released by the user pressing down an operation portion 106 of the lock mechanism 105, and the fixing device 80 moves to the second position (retreat position) illustrated in FIG. 6B without the user applying a force.

In the present exemplary embodiment, the lock mechanism 105 fixes the holding base 91 to fix the fixing device 80 so as not to move upward, the lock mechanism 105 may be configured to directly fix the fixing device 80.

A not-illustrated position restriction member (upward stopper) is provided so that the fixing device 80 stays at the second position after moving to the second position (retreat position). The fixing device 80 that has moved to the second position can be returned to the first position by the user pressing down on the fixing device 80. Upon returning to the first position, the fixing device 80 is automatically locked by the lock mechanism 105, and the fixing device 80 stays at the first position even if the user releases the fixing device 80. When the user presses down on the fixing device 80 to return the fixing device 80 to the first position, a not-illustrated position restriction member (downward stopper) is also provided to prevent the fixing device 80 from being pressed down too far.

### Notification Method of Jammed Sheet Removal Method

As described above, in the case where the printer 1 detects that the recording medium is not conveyed normally, or the sheet S remains in the conveyance path, the printer 1 notifies the user of the paper jam to urge the removal (paper jam clearance operation) of the remaining sheet S.

In the present exemplary embodiment, to make the work required when the user performs the paper jam clearance operation easier, the printer 1 displays, on the display unit 10 provided on the printer 1, the procedure of the paper jam clearance operation in characters and images to notify the user of the procedure. The notification method may be only in characters or in images, or other than that, may be in moving images or in sounds (sound generation unit).

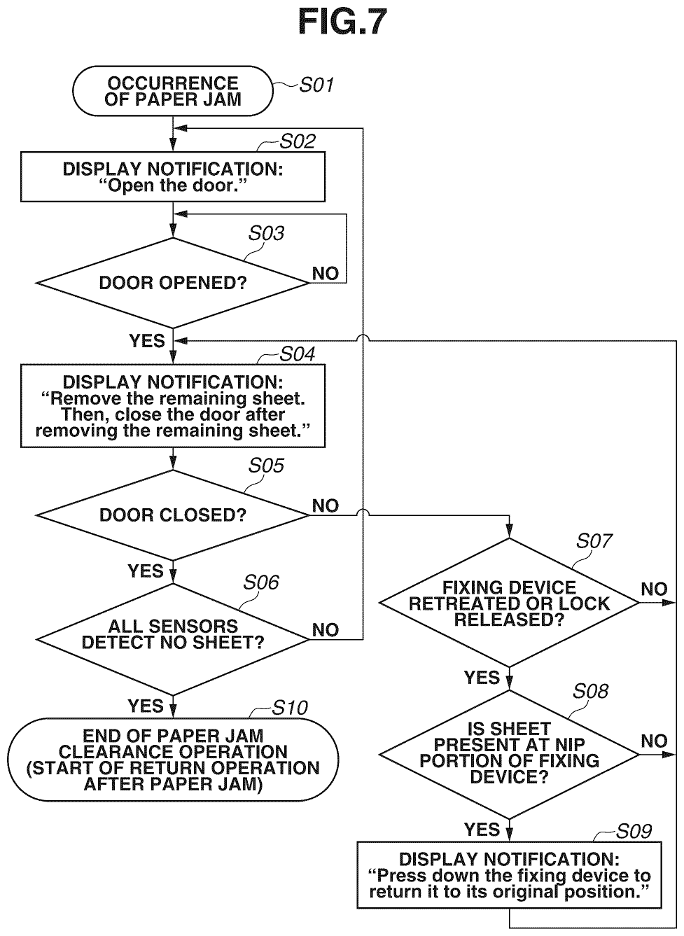

In the present exemplary embodiment, in a case where the paper jam clearance operation is to be performed in a state where the sheet S remains in the fixing device 80, the printer 1 notifies the user not to perform the paper jam clearance operation in a state where the fixing device 80 has moved to the second position (retreat position) or the fixing device 80 has started moving from the first position to the second position (retreat position). Specific notification contents will be described with reference to a flowchart in FIG. 7.

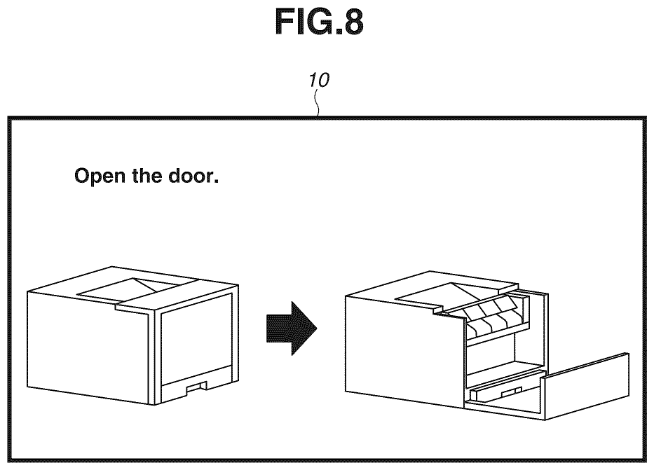

In step S01, in a case where the printer 1 (control unit 3) detects an occurrence of a paper jam of the sheet S, the processing proceeds to step S02. In step S02, the control unit 3 stops the image forming operation and displays a notification to open the door 20 on the display unit 10. In the present exemplary embodiment, the display unit 10 displays both images and characters at a time as illustrated in FIG. 8.

In step S03, the control unit 3 detects (determines) whether the door 20 is opened using a door sensor (not illustrated). In step S03, in a case where the control unit 3 determines that the door 20 is not opened (NO in step S03), the control unit 3 repeats the processing. In a case where the control unit 3 determines that the door 20 is opened (YES in step S03), the processing proceeds to step S04. In step S04, the control unit 3 display on the display unit 10 an instruction instructing the user to remove the remaining sheet S and to close the door 20.

In step S05, the control unit 3 determines whether the door 20 is closed. In a case where the user closes the door 20 (YES in step S05), the processing proceeds to step S06. In step S06, the control unit 3 determines whether all the sensors (i.e., sheet feed portion sensor 13, registration portion sensor 14, transfer-fixing in-between portion sensor 15, fixed sheet discharge portion sensor 85, and sheet discharge portion sensor 11) in the conveyance path of the printer 1 detect that no sheet S is present (i.e., whether the paper jam clearance operation is completed). In step S06, in a case where the paper jam clearance operation is completed (YES in step S06), the processing proceeds to step S10. In step S10, the control unit 3 performs the return operation. In step S06, in a case where the paper jam clearance operation is not completed (NO in step S06), the processing returns to step S02 to continue the processing.

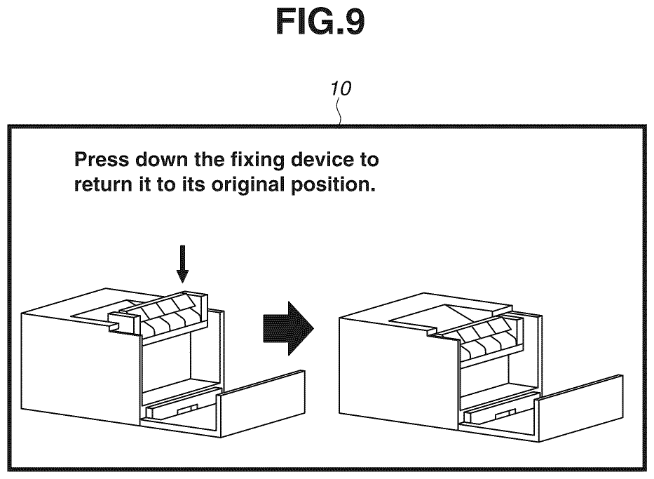

In step S05, in a case where the door 20 is not closed (NO in step S05), the processing proceeds to step S07. In step S07, the control unit 3 determines whether the fixing device 80 has retreated or the operation of the retreat has started before the user closes the door 20. In a case where the control unit 3 determines that the fixing device 80 has retreated or the operation of the retreat has started (YES in step S07), the processing proceeds to step S08. On the other hand, in a case where the control unit 3 determines that the fixing device 80 has not retreated or the operation of the retreat has not started (NO in step S07), the processing returns to step S04. In step S08, the control unit 3 checks whether the sheet S is present at the nip position of the fixing device 80. In a case where the sheet S is present at the nip position of the fixing device 80 (YES in step S08), the processing proceeds to step S09. In step S09, the control unit 3 notifies the user to press down the fixing device 80 to return it to the first position. In the present exemplary embodiment, as illustrated in FIG. 9, the control unit 3 notifies the user by displaying characters and images on the display unit 10. In step S08, in a case where the sheet S is not present at the nip position of the fixing device 80 (NO in step S08), the processing returns to step S04.

In the present exemplary embodiment, in step S07, the control unit 3 detects whether the fixing device 80 has moved from the first position based on the change of the connection state of the electric circuits between the fixing device 80 and the printer 1 main body.

More specifically, in the case where the fixing device 80 has moved from the first position, the connector 16 on the printer 1 main body and the connector 89 on the fixing device 80 illustrated in FIG. 2 are disconnected, and the signal lines connecting the thermistor 87 and the control unit 3 are disconnected, and the signal lines connecting the memory unit 88 and the control unit 3 are disconnected. The control unit 3 detects the disconnection of the signal lines based on the change of the connection state, to detect that the fixing device 80 has moved from the first position.

In step S08, the control unit 3 determines whether the sheet S remains at the fixing nip portion 90 using a method illustrated below.

The control unit 3 determines whether the leading edge of the sheet S has reached the fixing nip portion 90, by detecting the time period from a timing at which the leading edge of the sheet S passes the transfer-fixing in-between portion sensor 15 disposed immediately before the fixing nip portion 90 to a timing at which a paper jam occurs and the printer 1 stops operation, and converting the time period into the moving distance of the leading edge of the sheet S. Further, the control unit 3 determines whether the trailing edge of the sheet S has passed through the fixing nip portion 90 based on the signal from the fixed sheet discharge portion sensor 85.

### Effects of Present Exemplary Embodiment

An issue that will occur in a case of removing the sheet S from the fixing device 80 (fixing nip portion 90) in a state where the fixing device 80 has moved to the second position (retreat position) or a state after the fixing device 80 starts moving from the first position to the second position (retreat position) will be described.

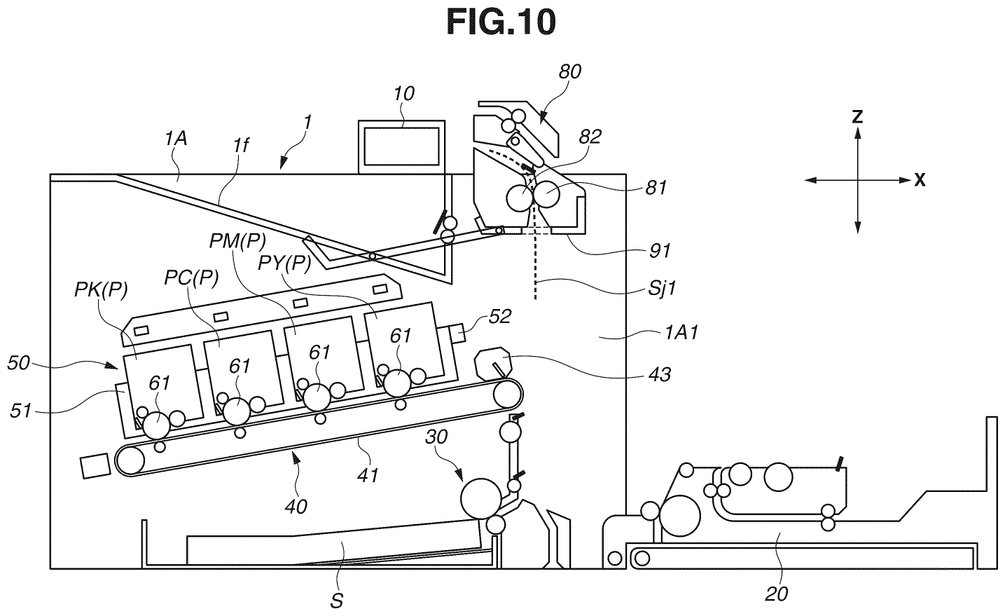

FIG. 10 illustrates a state where the fixing device 80 has moved to the second position (retreat position) before the paper jam clearance operation is performed in a state where the leading edge of the sheet Sj1 is present in the fixing device 80. In this case, according to the flowchart in FIG. 7, pulling out the sheet Sj1 downward after pressing down the fixing device 80 and fixing the fixing device 80 to the printer 1 main body is a proper paper jam clearance operation.

However, in a case where the sheet Sj1 is to be pulled out downward in the state illustrated in FIG. 10, if the pulling-out force is stronger than the force of the extension spring 103 pushing up the fixing device 80, the fixing device 80 moves also downward, and it becomes difficult to pull out the sheet S.

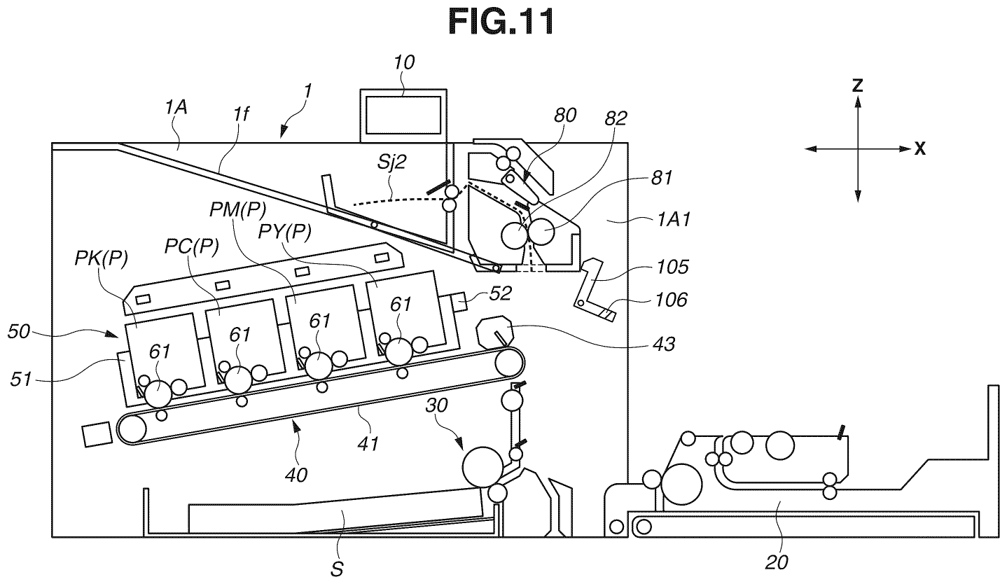

FIG. 11 illustrates a state where the sheet Sj2 is jammed in a state of having reached the sheet discharge roller pair 12, the lock mechanism 105 of the fixing device 80 is released before the paper jam clearance operation, and the fixing device 80 has just started to move to the second position (retreat position).

In this case, because the fixing device 80 is urged upward in a state where the sheet Sj2 is held by both the sheet discharge roller pair 12 and the fixing nip portion 90, a strong tensile force acts on the sheet Sj2 nipped between the sheet discharge roller pair 12 and the fixing nip portion 90. Thus, even if the user opens the fixed sheet discharge unit 86 to remove the sheet Sj2, it is difficult for the user to grasp and remove the sheet Sj2. Since a step appears between the fixed sheet discharge unit 86 and the sheet discharge roller pair 12 to cause the sheet Sj2 to be folded, in also a case where the sheet Sj2 is pulled out from the discharge tray 1f to perform the paper jam clearance operation, and since the sheet Sj2 is torn on the way, it is difficult to remove the sheet S.

By performing the paper jam clearance operation in a state where the fixing device 80 has returned to the first position according to the instructed paper jam clearance operation procedure, the paper jam clearance operation can be easily performed without the tensile force acting on the sheet Sj2.

As described above, in the printer 1 according to the present exemplary embodiment, the fixing device 80 can move between the first position at which the printer 1 performs image forming and the second position different from the first position, by the user's operation in the state where the door 20 is open. In the case where the paper jam of the sheet S has occurred during the image forming, the display unit 10 notifies the user to open the door 20 and remove the sheet S. After this notification, in a case where the user has moved the fixing device 80 from the first position to the second position, or the printer 1 detects that the fixing device 80 has started moving to the second position, the display unit 10 notifies the user to remove the sheet S after returning the fixing device 80 to the first position. In this way, the user can easily perform the paper jam clearance operation.

A second exemplary embodiment is described. In the present exemplary embodiment, a case where the printer 1 (control unit 3) cannot detect that the fixing device 80 has moved to the second position (retreat position) is described. In a case where the electric connection between the fixing device 80 and the printer 1 is maintained even though the fixing device 80 has moved to the second position (retreat position), the printer 1 cannot detect whether the fixing device 80 has started moving from the first position, unlike the first exemplary embodiment, which can.

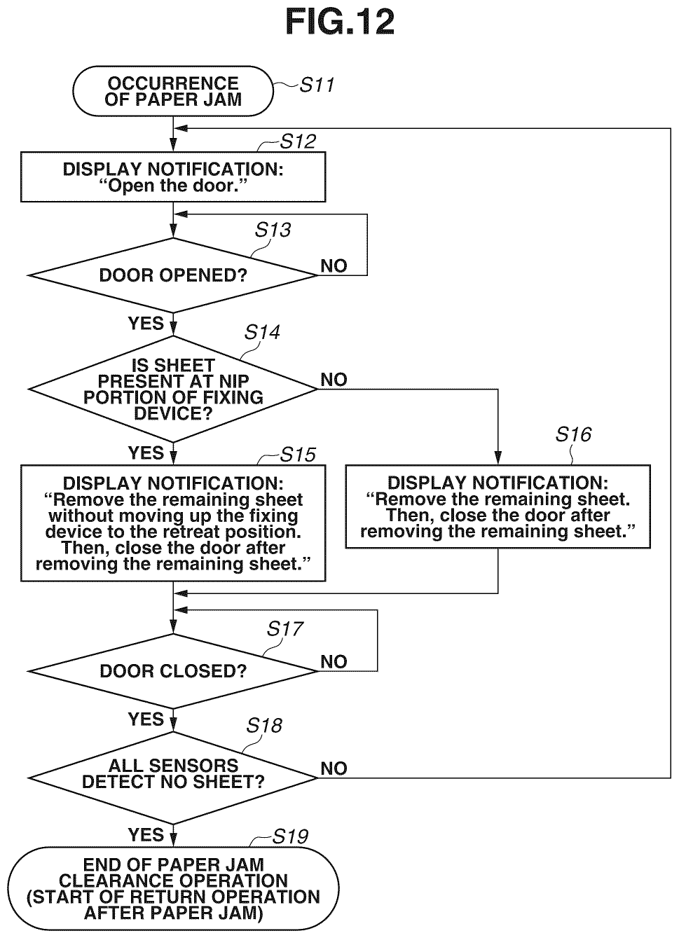

FIG. 12 is a flowchart illustrating a procedure of a paper jam clearance operation according to the second exemplary embodiment. In step S11, in a case where the control unit 3 detects the paper jam of the sheet S, the processing proceeds to step S12. In step S12, the control unit 3 causes the display unit 10 to display an instruction to open the door 20. In the present exemplary embodiment, similar to the procedure illustrated in FIG. 7 of the first exemplary embodiment, images and characters are both displayed on the display unit 10.

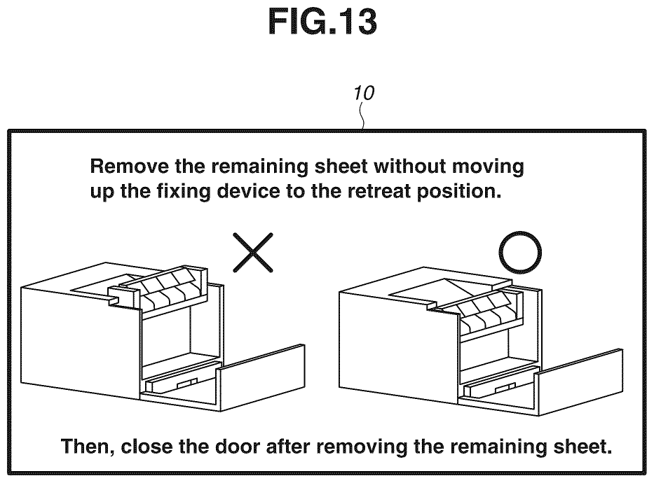

In step S13, the control unit 3 detects (determines) whether the user has opened the door 20 using a not-illustrated door sensor. In a case where the control unit 3 determines that the user has opened the door 20 (YES in step S13), the processing proceeds to step S14. On the other hand, in a case where the control unit 3 determines that the user has not opened the door 20 (NO in step S13), the control unit 3 repeats the processing. In step S14, the control unit 3 changes the display contents depending on whether the remaining sheet S is present in the fixing nip portion 90. In a case where the sheet S is not present in the fixing nip portion 90 (NO in step S14), the processing proceeds to step S16. In step S16, the control unit 3 notifies the user in characters to remove the sheet S and then close the door 20 after completing the removal. In a case where the sheet S is present in the fixing nip portion 90 (YES in step S14), the processing proceeds to step S15. In step S15, the control unit 3 notifies the user in images and characters illustrated in FIG. 13 to remove the sheet S without moving up the fixing device 80 to the second position (retreat position) and then close the door 20 after completing the removal.

In step S17, the control unit 3 determines whether the user has closed the door 20. In a case where the user has closed the door 20 (YES in step S17), the processing proceeds to step S18. On the other hand, in a case where the user has not closed the door 20 (NO in step S17), the control unit 3 repeats the processing. In step S18, the control unit 3 determines whether all the sensors (i.e., sheet feed portion sensor 13, registration portion sensor 14, transfer-fixing in-between portion sensor 15, fixed sheet discharge portion sensor 85, and sheet discharge portion sensor 11) in the conveyance path of the printer 1 detect that no sheet S is present to check whether the sheet S is removed (the paper jam clearance operation is completed). In a case where the paper jam clearance operation is completed (YES in step S18), the processing proceeds to step S19. In step S19, the control unit 3 performs the return operation. In a case where the paper jam clearance operation is not completed (NO in step S18), the processing returns to step S12.

As described above, in the printer 1 according to the present exemplary embodiment, in the case where the paper jam of the sheet S has occurred during the image forming, the display unit 10 notifies the user to open the door 20 and remove the sheet S without moving the fixing device 80 to the second position. In this way, the user can easily perform the paper jam clearance operation.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-075702, which was filed on May 8, 2024 and which is hereby incorporated by reference herein in its entirety.

What is claimed is:

1. An image forming apparatus comprising:
an image forming unit configured to form a toner image on a recording medium;
a fixing unit configured to fix the toner image formed on the recording medium onto the recording medium;
an open/close member configured to be openable so that an inside of the image forming apparatus is opened; and
a notification unit configured to notify a user,
wherein the fixing unit is configured to be movable by a user's operation between a first position at which image forming is performed and a second position different from the first position, in a state where the open/close member is opened,
wherein in a case where a paper jam of the recording medium occurs during the image forming, the notification unit notifies the user to open the open/close member and remove the recording medium, and
wherein in a case where the user moves the fixing unit from the first position to the second position or the image forming apparatus detects a start of moving the fixing unit to the second position after the user is notified, the notification unit notifies the user to remove the recording medium after returning the fixing unit to the first position.

2. The image forming apparatus according to claim 1, further comprising a housing configured to house the image forming unit and the fixing unit,
wherein the second position is a position at which the fixing unit protrudes from the housing.

3. The image forming apparatus according to claim 1, wherein the notification unit is a display unit provided on the image forming apparatus, and notifies the user using a character, an image, or a moving image displayed on the display unit.

4. The image forming apparatus according to claim 1, wherein the notification unit is a sound generation unit provided on the image forming apparatus and configured to notify the user using a sound.

5. An image forming apparatus comprising:
an image forming unit configured to form a toner image on a recording medium;
a fixing unit configured to fix the toner image formed on the recording medium onto the recording medium;
an open/close member configured to be openable so that an inside of the image forming apparatus is opened; and
a notification unit configured to notify a user,
wherein the fixing unit is configured to be movable by a user's operation between a first position at which image forming is performed and a second position different from the first position, in a state where the open/close member is opened, and
wherein in a case where a paper jam of the recording medium occurs during the image forming, the notification unit notifies the user to open the open/close member and remove the recording medium without moving the fixing unit to the second position.

6. The image forming apparatus according to claim 5, further comprising a housing configured to house the image forming unit and the fixing unit,
wherein the second position is a position at which the fixing unit projects from the housing.

7. The image forming apparatus according to claim 5, wherein the notification unit is a display unit provided on the image forming apparatus, and notifies the user using a character, an image, or a moving image displayed on the display unit.

8. The image forming apparatus according to claim 5, wherein the notification unit is a sound generation unit provided on the image forming apparatus and configured to notify the user using a sound.
